(19) United States
(12) Patent Application Publication
(10) Pub. No.: US 2025/0014137 A1
(43) Pub. Date: Jan. 9, 2025

(54) MANAGEMENT DEVICE, MANAGEMENT METHOD, AND COMPUTER- READABLE STORAGE MEDIUM

(71) Applicant: NEC Corporation, Minato-ku, Tokyo (JP)

(72) Inventors: Remi TANAKA, Tokyo (JP); Takeshi Shouta, Tokyo (JP); Hiroyuki Kakinuma, Tokyo (JP); Tomoyuki MUTO, Tokyo (JP)

(73) Assignee: NEC Corporation, Minato-ku, Tokyo (JP)

(21) Appl. No.: 18/712,290

(22) PCT Filed: Dec. 16, 2021
(86) PCT No.: PCT/JP2021/046475

§ 371 Date: May 22, 2024

(51) Int. Cl. G06Q 50/40; G07B 15/02

(52) U.S. Cl. CPC G06Q 50/40; G07B 15/02

(57) ABSTRACT

One of the purposes of the present invention is to provide a management device that make it possible to properly calculate the tolls required for corridor transit. A management device according to one embodiment of the present disclosure comprises: an acquisition means for acquiring position information of a flying mobile unit, and corridor information which includes information on tolls and which is defined for a corridor that is a specific airspace; an identification means for identifying, on the basis of the position information, a transit area, which is an area in the corridor that the mobile unit has transited; and a calculation means for calculating a toll corresponding to the transit area on the basis of the corridor information.

### TECHNICAL FIELD

The present disclosure relates to a technique for managing a corridor through which a mobile unit transits.

### BACKGROUND ART

A flying mobile unit may be used in fields such as transportation and distribution. In such a case, a mobile unit control method for safely operating a mobile unit has been studied.

Cited Document 1 discloses that location data including map information and route data that is information on a road in the sky are transmitted to an aerial vehicle, and the aerial vehicle is caused to display an empty area where the aerial vehicle can operate.

### CITATION LIST

### Patent Literature

PTL 1: JP 2020-205103

### SUMMARY OF INVENTION

### Technical Problem

For safe operation of the mobile unit, it has been studied to create airspaces through which the mobile units transit. Such a specific airspace is also referred to as a corridor. A fee required for transit may be set for the corridor. The manager of the corridor collects the fee from the owner of the mobile unit that has used the corridor in which the fee is set. At this time, the fee to be collected from the owner of the mobile unit may be different depending on the usage situations of the corridor.

The present disclosure has been made in view of the above problems, and one of the objects is to provide a management device and the like capable of appropriately calculating a fee required for corridor transit.

### Solution to Problem

A management device according to one aspect of the present disclosure includes an acquisition means that acquires position information of a flying mobile unit, and corridor information which includes information on tolls and which is defined for a corridor that is a specific airspace, a specifying means that specifies, based on the position information, a transit area, which is an area in the corridor that the mobile unit has transited, and a calculation means that calculates a toll corresponding to the transit area based on the corridor information.

A management method according to one aspect of the present disclosure includes acquiring position information of a flying mobile unit, and corridor information which includes information on tolls and which is defined for a corridor that is a specific airspace: specifying, based on the position information, a transit area which is an area in the corridor that the mobile unit has transited; and calculating a toll corresponding to the transit area based on the corridor information.

A computer-readable storage medium according to one aspect of the present disclosure storing a program for causing a computer to execute a process of acquiring position information of a flying mobile unit, and corridor information which includes information on tolls and which is defined for a corridor that is a specific airspace, a process of specifying, based on the position information, a transit area, which is an area in the corridor that the mobile unit has transited, and a process of calculating a toll corresponding to the transit area based on the corridor information.

### Advantageous Effects of Invention

According to the present disclosure, a fee required for corridor transit can be appropriately calculated.

### BRIEF DESCRIPTION OF DRAWINGS

FIG. 1 is a diagram schematically illustrating an example of a configuration including a management device according to a first example embodiment of the present disclosure.

FIG. 2 is a conceptual diagram illustrating an example of a corridor according to the first example embodiment of the present disclosure.

FIG. 3 is a block diagram illustrating an example of a functional configuration of the management device according to the first example embodiment of the present disclosure.

FIG. 4 is a flowchart describing an example of an operation of the management device according to the first example embodiment of the present disclosure.

FIG. 5 is a block diagram illustrating an example of a functional configuration of a management device according to a second example embodiment of the present disclosure.

FIG. 6 is a diagram illustrating an example of corridor information according to the second example embodiment of the present disclosure.

FIG. 7 is a diagram illustrating an example of owner information according to the second example embodiment of the present disclosure.

FIG. 8 is a flowchart describing an example of an operation of the management device according to the second example embodiment of the present disclosure.

FIG. 9 is a conceptual diagram illustrating an example of an area including a corridor according to a second modified example of the present disclosure as viewed from above.

FIG. 10 is a conceptual diagram illustrating an example of a corridor according to a third example embodiment of the present disclosure.

FIG. 11 is a block diagram illustrating an example of a functional configuration of a management device according to the third example embodiment of the present disclosure.

FIG. 12 is a diagram illustrating an example of owner information according to the third example embodiment of the present disclosure.

FIG. 13 is a diagram illustrating an example of corridor information according to the third example embodiment of the present disclosure.

FIG. 14 is a diagram illustrating an example of option information according to the third example embodiment of the present disclosure.

FIG. 15 is a flowchart describing an example of an operation of the management device according to the third example embodiment of the present disclosure.

FIG. 16 is a block diagram illustrating an example of a functional configuration of a management device according to a fourth example embodiment of the present disclosure.

FIG. 17 is a diagram illustrating an example of a flight plan according to the fourth example embodiment of the present disclosure.

FIG. 18 is a diagram illustrating an example of a flight record according to the fourth example embodiment of the present disclosure.

FIG. 19 is a flowchart describing an example of an operation of the management device according to the fourth example embodiment of the present disclosure.

FIG. 20 is a block diagram illustrating an example of a hardware configuration of a computer device that implements the management device according to first, second, third, and fourth example embodiments of the present disclosure.

### EXAMPLE EMBODIMENT

Hereinafter, example embodiments of the present disclosure will be described with reference to the drawings.

### First Example Embodiment

An outline of a management device of the present disclosure will be described.

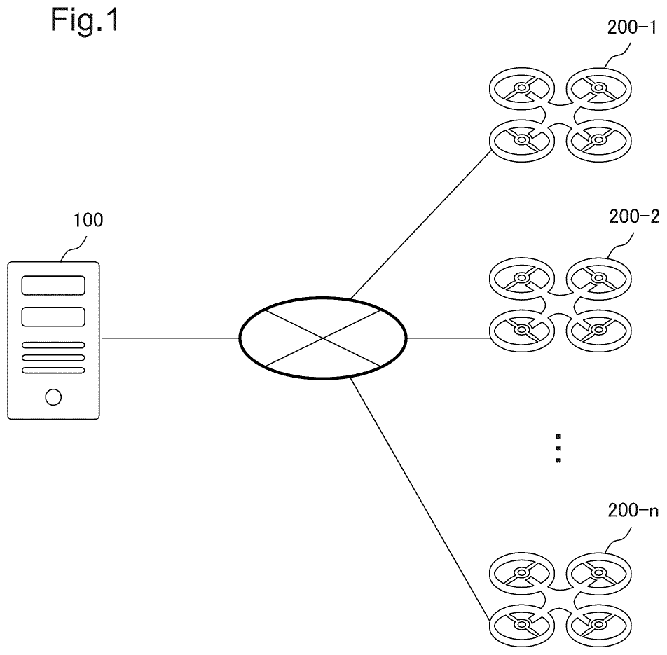

FIG. 1 is a diagram schematically illustrating an example of a configuration including a management device 100. As illustrated in FIG. 1, the management device 100 is communicably connected to mobile units 200-1, 200-2, . . . , and 200-n (n is a natural number equal to or greater than 1) via a wireless or wired network. Here, in a case where the mobile units 200-1, 200-2, . . . , and 200-n are not distinguished from one another, the mobile units 200-1, 200-2, . . . , and 200-n are referred to as a mobile unit 200.

The mobile unit is a manned or unmanned aerial vehicle. The mobile unit is, for example, an airplane, a helicopter, an airship, a multicopter (also called multi-rotor helicopter, or multi-rotor, etc.), or the like. Unmanned aerial vehicles may also be referred to as UAVs (Unmanned Aerial Vehicles), small unmanned machines or drones. The mobile unit is not limited to this example. The mobile unit may be any device capable of flying through the corridor.

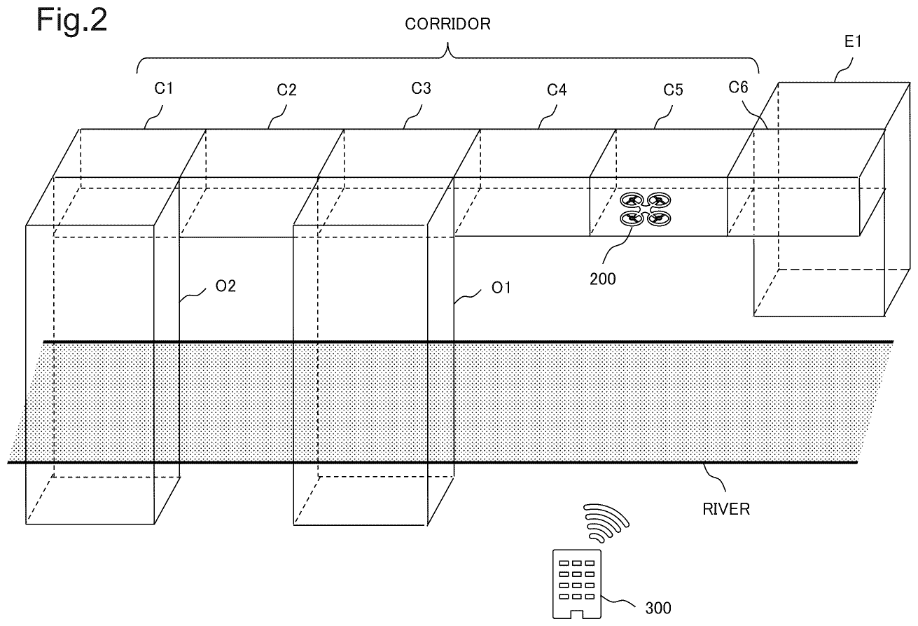

Next, a corridor in the present disclosure will be described. The corridor is an area formed in the air and indicates a specific airspace through which a mobile unit transits. Here, the corridor may include a dedicated airspace for the mobile unit transit, in which a service for allowing the mobile unit to transit safely is provided. Such a dedicated airspace, particularly an airspace specialized for drones, may be referred to as a drone highway. FIG. 2 is a conceptual diagram illustrating an example of a corridor. In the example of FIG. 2, an area through which a mobile unit transits is indicated by a virtual block. In this example, the corridor is formed in the sky above the river. Areas C1 to C6 indicate corridors. For example, the mobile unit 200 enters the corridor by moving from the area E1 to the area C6. The mobile unit 200 moves, for example, in the order of the area C6, the area C5, the area C4, and the area C3. Then, the mobile unit 200 moves from the area C3 to the area O1 to exit from the corridor. Each area may be indicated by, for example, latitude, longitude, and altitude. In the example of FIG. 2, an example in which a corridor is formed in the sky above a river is illustrated, but a place where the corridor is formed is not limited to this example. For example, the corridor may be formed in the sky above a place having a lower population density than a residential area, such as the sea, mountains, and forests. In addition, the corridor may be formed above a railway track, below an elevated track, or the like.

Furthermore, for example, an observation device 300 may be arranged around the corridor. The observation device 300 is a device capable of communicating with the mobile unit 200. The observation device 300 and the mobile unit 200 communicate with each other by a communication method such as, for example, Bluetooth (registered trademark). The communication method is not limited to this example, and may be a known method. The observation device 300 receives transmitted information transmitted from a corridor and a mobile unit 200 transiting through an area around the corridor (e.g., areas E1, O1, O2). The transmitted information includes position information and identification information of the mobile unit 200. The mobile unit 200 may acquire the position information of the own machine by a positioning signal reception device mounted on the mobile unit 200. The positioning signal reception device, for example, receives a signal transmitted from a positioning satellite of a global navigation satellite system (GNSS) such as a global positioning system (GPS) satellite and acquires position information indicating the position of the positioning device based on the received signal. The position information may include information indicating the altitude of the own machine. The altitude is acquired by, for example, an altimeter mounted on the mobile unit 200. The transmitted information may be transmitted by, for example, a remote identification (ID) device mounted on the mobile unit. The observation device 300 transmits the transmitted information to the management device 100. In this manner, the management device 100 can acquire information transmitted from the mobile unit 200. The management device 100 may be a device integrated with the observation device 300.

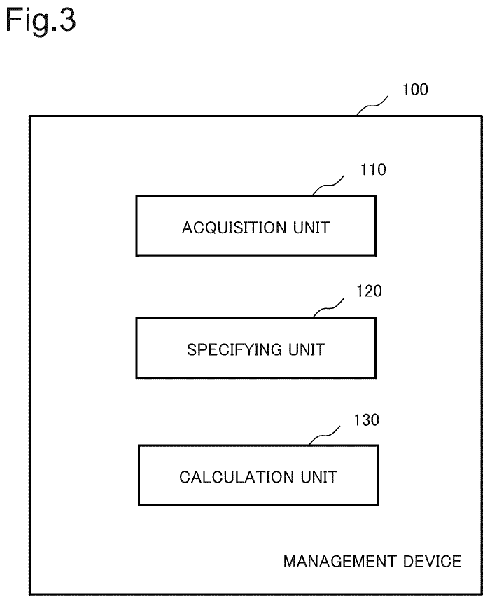

FIG. 3 is a block diagram illustrating an example of a functional configuration of the management device 100 of the first example embodiment. As illustrated in FIG. 3, the management device 100 includes an acquisition unit 110, a specifying unit 120, and a calculation unit 130.

The acquisition unit 110 acquires position information of the mobile unit 200. For example, the acquisition unit 110 acquires position information of the mobile unit by acquiring transmitted information transmitted from the mobile unit 200. In addition, the acquisition unit 110 acquires the corridor information. The corridor information includes information on a toll defined for the corridor. The information regarding the toll may be, for example, information indicating a fee corresponding to an area of a corridor. For example, in the case of the corridor information related to the corridor illustrated in the example of FIG. 2, information indicating a toll when transiting through a section from the area C3 to the area C6 and a toll when transiting through a section from the area C1 to the area C6 is included. The corridor information may be stored in an external device (not illustrated) capable of communicating with the management device 100, or may be stored in a storage device (not illustrated) included in the management device 100. The acquisition unit 110 acquires, for example, the corridor information from such an external device or storage device. The timing at which the acquisition unit 110 acquires the position information may be different from the timing at which the acquisition unit 110 acquires the corridor information.

In this manner, the acquisition unit 110 acquires the position information of the flying mobile unit and the corridor information including the information related to the toll defined for the corridor that is the specific airspace. The acquisition unit 110 is an example of an acquisition means.

The specifying unit 120 specifies an area of a corridor through which the mobile unit 200 transits based on the position information acquired by the acquisition unit 110. For example, the specifying unit 120 specifies that the mobile unit 200 has transited through the area E1, the area C6, the area C5, the area C4, the area C3, and the area O1 in this order from the position information. In this case, the specifying unit 120 specifies an area of the corridor through which the mobile unit 200 has transited as the area C6, the area C5, the area C4, and the area C3. As a result, it is possible to recognize which part of the area of the corridor the mobile unit 200 has used. Here, in the present disclosure, an area through which the mobile unit 200 has transited in the corridor is also referred to as a transit area. In this example, the transit area is a section from the area C6 to the area C3.

In this manner, the specifying unit 120 specifies a transit area that is an area through which the mobile unit has transited in the corridor based on the position information. The specifying unit 120 is an example of a specifying means.

The calculation unit 130 calculates a toll for the mobile unit 200. For example, the calculation unit 130 specifies the toll corresponding to the transit area specified by the specifying unit 120 from the corridor information. Then, for example, the calculation unit 130 calculates the specified toll as the toll for the mobile unit 200.

In this manner, the calculation unit 130 calculates the toll corresponding to the transit area based on the corridor information. The calculation unit 130 is an example of a calculation means.

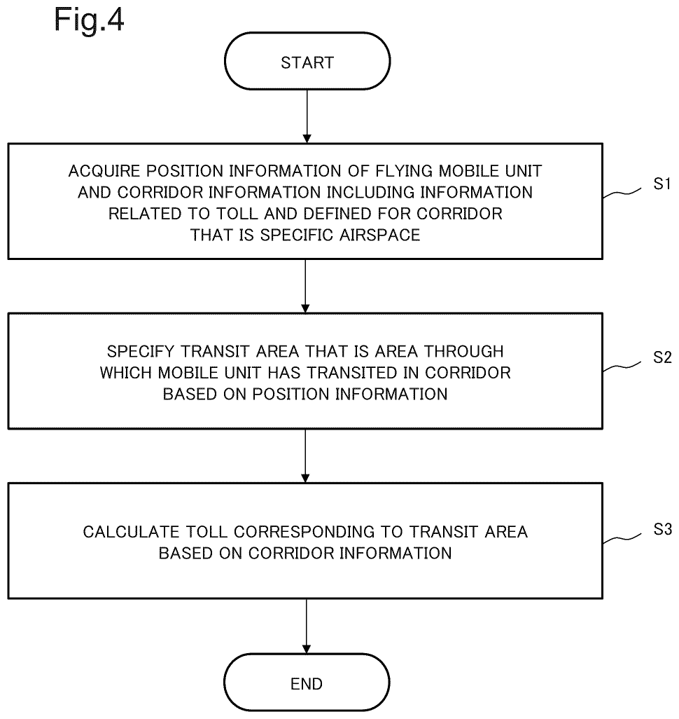

Next, an example of the operation of the management device 100 will be described with reference to FIG. 4. In the present disclosure, each step in the flowchart is represented using a number assigned to each step, such as “S1”.

FIG. 4 is a flowchart illustrating an example of the operation of the management device 100. The acquisition unit 110 acquires the position information of the flying mobile unit and the corridor information including the information related to the toll defined for the corridor that is the specific airspace (S1). The specifying unit 120 specifies a transit area that is an area through which the mobile unit has transited in the corridor based on the position information (S2). The calculation unit 130 calculates the toll corresponding to the transit area based on the corridor information (S3).

As described above, the management device 100 of the first example embodiment acquires the position information of the flying mobile unit and the corridor information including the information related the toll defined for the corridor that is the specific airspace. Then, the management device 100 specifies a transit area which is an area through which the mobile unit has transited in the corridor based on the position information, and calculates a toll corresponding to the transit area based on the corridor information. As a result, the management device 100 can calculate the fee corresponding to the use of the corridor. For example, even when the toll changes according to the usage situations of the corridor, the management device 100 can calculate an appropriate fee. That is, the management device 100 of the first example embodiment can appropriately calculate the fee required for corridor transit.

### Second Example Embodiment

Next, a management device according to a second example embodiment will be described. In the second example embodiment, the management device 100 described in the first example embodiment will be described in more detail. Description of contents redundant with the contents described in the first example embodiment will be partially omitted.

### [Details of Management Device 100]

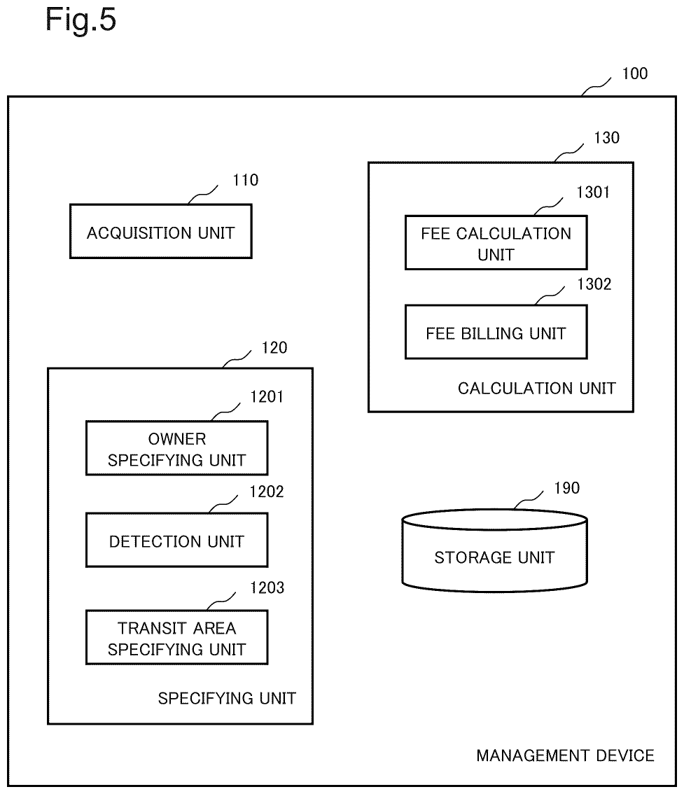

FIG. 5 is a block diagram illustrating an example of a functional configuration of the management device 100 of the second example embodiment. As illustrated in FIG. 5, the management device 100 includes an acquisition unit 110, a specifying unit 120, and a calculation unit 130. In addition, the management device 100 includes a storage device 190. The storage device 190 may be an external device capable of communicating with the management device 100. The storage device 190 is an example of a storage means

The acquisition unit 110 acquires transmitted information and corridor information. The transmitted information includes position information and identification information of the mobile unit 200. The transmitted information may further include information of a time when the mobile unit 200 has transmitted the transmitted information. The acquisition unit 110 may periodically acquire the transmitted information. For example, it is assumed that the mobile unit 200 transmits the transmitted information once per second. In this case, the management device 100 may acquire the transmitted information every time the mobile unit 200 transmits the information via the observation device 300. The acquisition unit 110 may store the acquired transmitted information in the storage device 190 for each identification information.

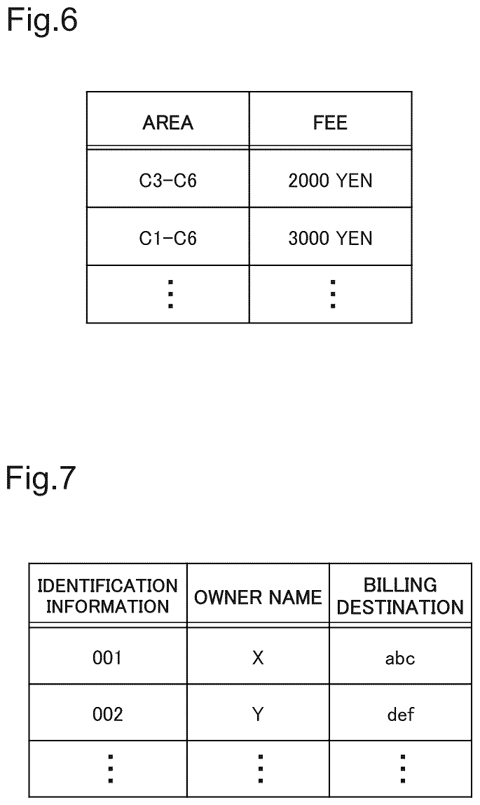

The corridor information is stored in the storage device 190. That is, the acquisition unit 110 acquires the corridor information from the storage device 190. FIG. 6 is an example of the corridor information. The example of FIG. 6 is information related to a toll defined for the corridor illustrated in the example of FIG. 2. For example, in a record in the first line a fee of 2000 yen is defined for a section from the area C3 to the area C6. This indicates that the owner of the mobile unit 200 needs to pay 2000 yen when transiting through the section from the area C3 to the area C6. As described above, the corridor information includes, for example, information indicating a fee defined for each section of the corridor. Furthermore, the corridor information may include information indicating an area of the entire corridor.

The specifying unit 120 includes an owner specifying unit 1201, a detection unit 1202, and a transit area specifying unit 1203. The owner specifying unit 1201 specifies the owner of the mobile unit 200. The transmitted information acquired by the acquisition unit 110 includes identification information. The specifying unit 120 specifies information associated with the identification information included in the transmitted information based on the owner information. FIG. 7 is a diagram illustrating an example of the owner information. The owner information is information regarding the owner of the mobile unit 200. For example, assume that identification information “001” is included in the acquired transmitted information. In this case, the specifying unit 120 specifies information indicating the owner name “X” and the billing destination “abc” associated with the identification information “001”. Here, the billing destination indicates a billing destination of the toll. The billing destination may be, for example, information indicating a bank account of the owner or information indicating a credit card of the owner. The owner information may further include a contact, an address, and the like of the owner. The contact may be, for example, an email address owned by the owner, or may be an account of the owner in a web service. The contact may indicate a place that can be viewed by the owner.

The detection unit 1202 detects whether the mobile unit 200 has entered the corridor or whether the mobile unit 200 has exited from the corridor. For example, the detection unit 1202 specifies an area where the mobile unit is located from the position information of the mobile unit 200. In a case where the area where the mobile unit is located changes from the outside of the area of the corridor to the inside of the area of the corridor, the detection unit 1202 detects that the mobile unit 200 has entered the corridor. In addition, in a case where the area where the mobile unit is located changes from the inside of the area of the corridor to the outside of the area of the corridor, the detection unit 1202 detects that the mobile unit has exited from the corridor. In the example of FIG. 2, when the mobile unit 200 moves from the area E1 to the area C6, the detection unit 1202 detects that the mobile unit 200 has entered the corridor. In addition, for example, when the mobile unit 200 moves from the area C1 to the area 2, the detection unit 1202 detects that the mobile unit 200 has exited from the corridor. In this manner, the detection unit 1202 detects entry and exit of the mobile unit 200 to and from the corridor based on the position information.

The transit area specifying unit 1203 specifies a transit area that is an area through which the mobile unit 200 has transited in the corridor. For example, assume that the detection unit 1202 detects that the mobile unit 200 has exited from the corridor. At this time, the transit area specifying unit 1203 specifies the transit area of the mobile unit 200 that has exited from the corridor. For example, assume that the mobile unit 200 enters the area C6 from the area E1 and exits to the area O1 from the area C3. In this case, for example, the transit area specifying unit 1203 specifies a section from the area C6 to the area C3 as the transit area of the mobile unit 200. The transit area specifying unit 1203 may store the specified transit area in the storage device 190 in association with the identification information of the mobile unit 200. As described above, for example, the transit area specifying unit 1203 specifies a section of a corridor through which a mobile unit has transited as a transit area.

The calculation unit 130 includes a fee calculation unit 1301 and a fee billing unit 1302. The fee calculation unit 1301 calculates a toll of the mobile unit 200 that has transited through the corridor. Specifically, the fee calculation unit 1301 calculates a fee corresponding to the transit area specified by the transit area specifying unit 1203. For example, assume that the transit area indicates a section from the area C6 to the area C3. Then, assume that the acquisition unit 110 has acquired the corridor information illustrated in FIG. 6. In this case, the fee calculation unit 1301 calculates “2000 yen” or the fee corresponding to the section from the area C6 to the area C3 as the toll. In this manner, the fee calculation unit 1301 calculates the fee corresponding to the section indicated in the transit area as the toll.

The fee billing unit 1302 bills the fee. Specifically, the fee billing unit 1302 bills the toll calculated by the fee calculation unit 1301 to the owner specified by the owner specifying unit 1201. For example, assume that a toll of 2000 yen is calculated for a mobile unit of identification information “001”. The fee billing unit 1302 charges 2000 yen to the billing destination “abc” associated with the identification information “001” based on the owner information illustrated in FIG. 7. In a case where the billing destination is the bank account, the fee billing unit 1302 withdraws the toll from the bank account indicated in the billing destination. In a case where the billing destination is a credit card, the fee billing unit 1302 performs payment for the toll with the credit card indicated in the billing destination.

### Operation Example of Management Device 100

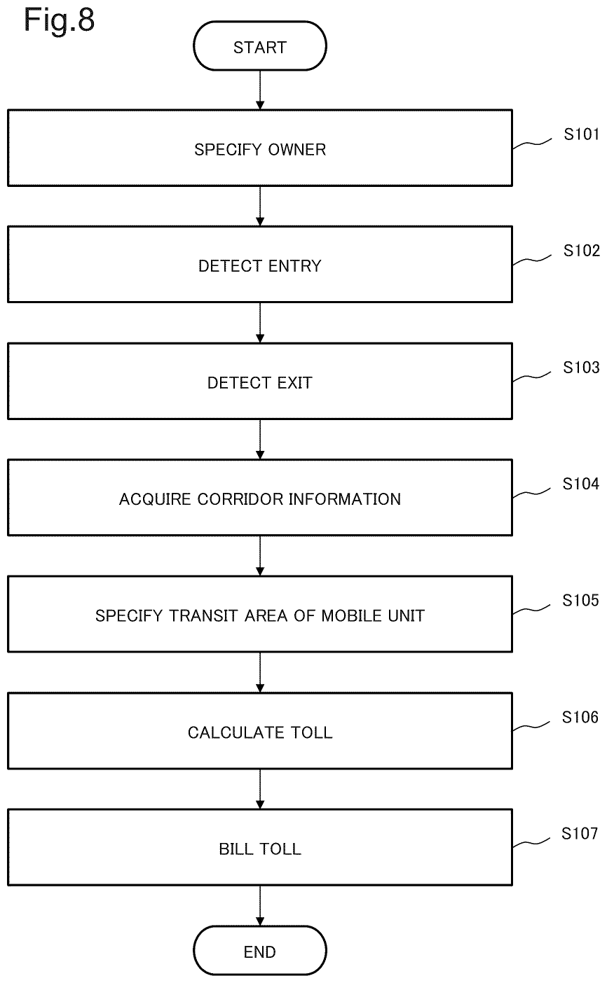

Next, an example of the operation of the management device 100 will be described with reference to FIG. 8. In the present operation example, the acquisition unit 110 acquires the transmitted information as needed.

FIG. 8 is a flowchart illustrating an example of the operation of the management device 100. The process of the present operation example may be proceeded after the mobile unit 200 is located in an area (e.g., the area E1) in the vicinity of the corridor. In this case, the detection unit 1202 may detect that the mobile unit 200 is located in an area in the vicinity of the corridor.

First, the owner specifying unit 1201 specifies the owner based on the transmitted information (S101). For example, the owner is specified from the owner information based on the identification information included in the transmitted information. The detection unit 1202 detects entry of the mobile unit 200 into the corridor (S102). For example, in a case where the position information of the mobile unit 200 moves from an area outside the corridor to an area inside the corridor, the detection unit 1202 detects the entry of the mobile unit 200 into the corridor. The detection unit 1202 detects exit of the mobile unit 200 from the corridor (S103). For example, in a case where the position information of the mobile unit 200 moves from an area inside the corridor to an area outside the corridor, the detection unit 1202 detects the exit of the mobile unit 200 from the corridor. The acquisition unit 110 acquires the corridor information (S104). The transit area specifying unit 1203 specifies an area of the corridor through which the mobile unit 200 has transited as a transit area (S105). The fee calculation unit 1301 calculates the toll to be billed to the owner of the mobile unit 200 based on the transit area (S106). Then, the fee billing unit 1302 bills the calculated toll to the billing destination of the specified owner (S107).

As described above, the management device 100 of the second example embodiment acquires the position information of the flying mobile unit and the corridor information including the information related the toll defined for the corridor that is the specific airspace. Then, the management device 100 specifies a transit area which is an area through which the mobile unit has transited in the corridor based on the position information, and calculates a toll corresponding to the transit area based on the corridor information. As a result, the management device 100 can calculate the fee corresponding to the use of the corridor. For example, even when the toll changes according to the usage situations of the corridor, the management device 100 can calculate an appropriate fee. That is, the management device 100 of the first example embodiment can appropriately calculate the fee required for corridor transit.

Furthermore, in the second example embodiment, the corridor information may include information indicating a fee defined for each section of the corridor. Then, the management device 100 may specify a section of the corridor through which the mobile unit has transited as a transit area, and calculate a fee corresponding to a section indicated in the transit area as the toll. As a result, the management device 100 can calculate an appropriate fee even when the toll changes according to the section of the corridor through which the mobile unit transits.

### First Modified Example

In the above example embodiment, an example has been described in which the information indicating the fee defined for each section of the corridor is included in the corridor information as the toll corresponding to the area of the corridor. The example of the corridor information is not limited to this example.

For example, the corridor information may include information indicating a fee defined for each distance by which the mobile unit has transited through the corridor as a toll corresponding to the area of the corridor. In this case, the corridor information includes, for example, information indicating that the fee per 10 km of the corridor is 2000 yen.

Then, the transit area specifying unit 1203 specifies a distance by which the mobile unit 200 has transited in the corridor as a transit area. For example, assume that the detection unit 1202 detects that the mobile unit 200 has exited from the corridor. At this time, the transit area specifying unit 1203 specifies the transit area of the mobile unit 200 that has exited from the corridor. A distance by which the mobile unit has transited through the corridor is specified as a transit area based on the position information. For example, assume that the mobile unit 200 enters the area C6 from the area E1 and exits to the area O1 from the area C3. In this case, for example, the transit area specifying unit 1203 specifies, as the transit area of the mobile unit 200, a distance from when the mobile unit 200 enters the area C6 to when the mobile unit 200 exits from the area O1.

The fee calculation unit 1301 calculates a fee corresponding to the distance indicated in the transit area as a toll. Specifically, the fee calculation unit 1301 calculates a fee corresponding to the transit area specified by the transit area specifying unit 1203. For example, assume that the transit area is 20 km. In this case, if the fee per 10 km of the corridor is 2000 yen, the fee calculation unit 1301 calculates 4000 yen as the toll.

As described above, the corridor information may include information indicating a fee defined for each distance by which the mobile unit has transited through the corridor. In this case, the management device 100 may specify a distance by which the mobile unit has transited in the corridor as a transit area, and calculate a fee corresponding to the distance indicated in the transit area as the toll. As a result, the management device 100 can calculate an appropriate fee even when the toll changes according to the distance by which the mobile unit has transited in the corridor.

### Second Modified Example

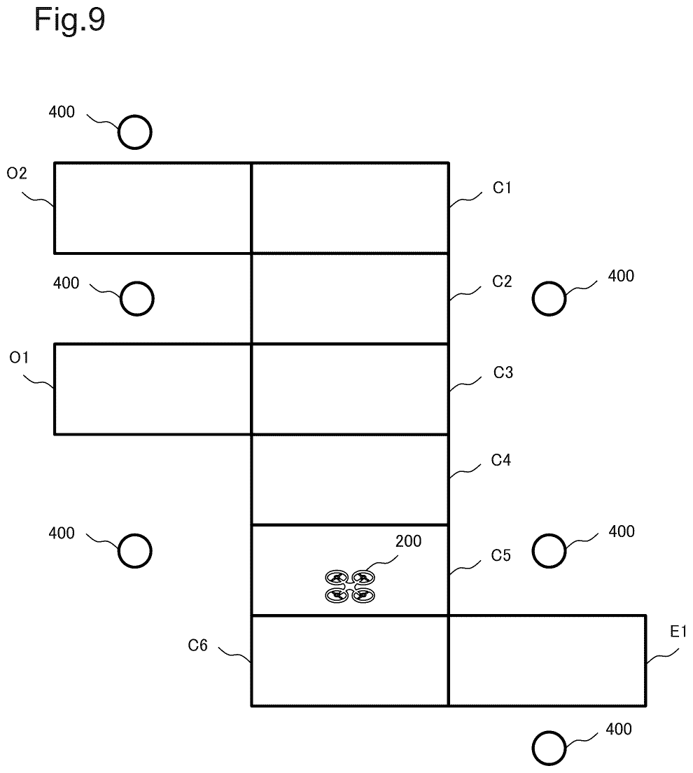

The position information may be acquired by a method not using the GNSS. For example, a positioning signal receiving device mounted on the mobile unit 200 may receive a signal transmitted from the positioning device 400 installed on the ground and acquire position information indicating the position of the own machine based on the received signal. FIG. 9 is a conceptual diagram illustrating an example when an area including a corridor is viewed from above. Specifically, FIG. 9 is a view of various areas illustrated in FIG. 2 as viewed from above. As illustrated in FIG. 9, the plurality of positioning devices 400 are installed in such a way as to sandwich the area. For example, in a case where a corridor is formed above a river, the positioning devices 400 may be installed on both banks of the river.

For example, in a case where the mobile unit 200 is in the area C5, signals are received from both of the positioning devices 400 installed on both banks of the river. Then, the positioning signal receiving device mounted on the mobile unit 200 may be configured to acquire the position information of the own machine using the principle of triangulation. In this case, various areas included in the corridor information are represented in a coordinate system similar to the position information acquired by the method.

### Third Example Embodiment

Next, a management device according to a third example embodiment will be described. In the third example embodiment, an example in which a toll is calculated according to various situations when a mobile unit transits through a corridor will be described. Description of contents redundant with the contents described in the first and second example embodiments will be partially omitted.

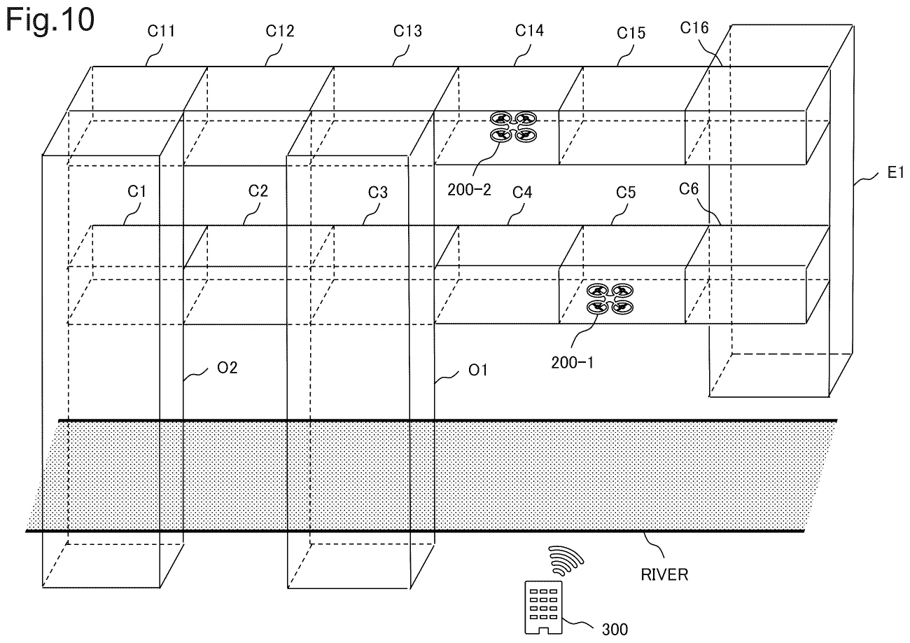

FIG. 10 is a conceptual diagram illustrating an example of a corridor. In the example of FIG. 10, a corridor is also formed above the corridor of the example of FIG. 2. The areas C1 to C6 are referred to as a corridor A, and the areas C11 to C16 are referred to as a corridor B. In the present example embodiment, as illustrated in FIG. 10, it is assumed that various areas including a corridor are formed.

### [Details of Management Device 101]

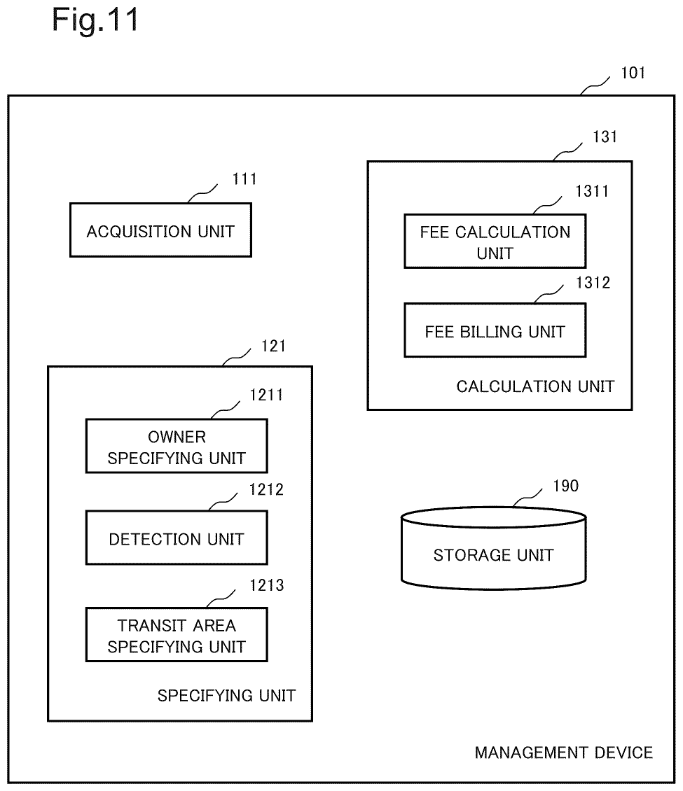

FIG. 11 is a block diagram illustrating an example of a functional configuration of a management device 101 according to the third example embodiment. As illustrated in FIG. 11, the management device 101 includes an acquisition unit 111, a specifying unit 121, and a calculation unit 131. In addition, the management device 101 includes a storage device 190.

In addition to the process of the acquisition unit 110, the acquisition unit 111 may perform processes described below. The acquisition unit 111 may acquire charging record information indicating a record in which the mobile unit 200 uses the charging facility. The charging facility (not illustrated) is a facility for charging the mobile unit 200. For example, a mobile unit 200 that uses a corridor and has a remaining amount of battery of less than a predetermined value moves to a charging facility and performs charging. The charging method may be a known method. At this time, the charging facility acquires transmitted information from the mobile unit 200, and transmits charging record information including identification information of the mobile unit 200 to the management device 101 via the observation device 300. At this time, the charging record information includes, for example, information indicating a time when the mobile unit 200 performs charging. Furthermore, the charging record information may include information indicating the amount of power at the time of charging and the remaining amount of battery of the mobile unit 200. The charging facility is installed, for example, around the corridor. The acquisition unit 11 may store the charging record information in the storage device 190.

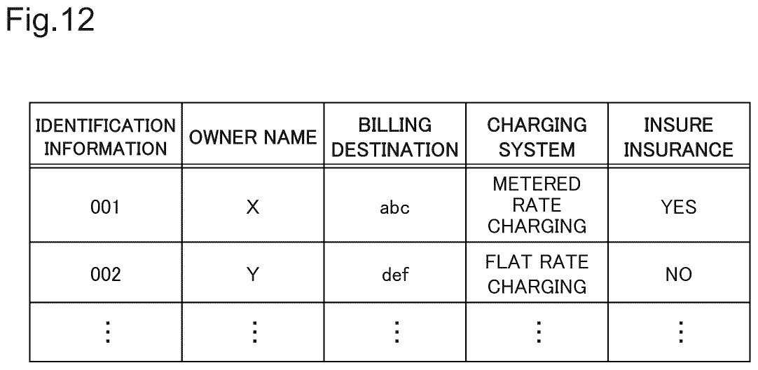

The specifying unit 121 may perform processes described below in addition to the process of the specifying unit 120. The specifying unit 121 includes an owner specifying unit 1211, a detection unit 1212, and a transit area specifying unit 1213. The owner specifying unit 1211 specifies the owner of the mobile unit 200 from the owner information. FIG. 12 is a diagram illustrating an example of the owner information. In the example of FIG. 12, the information on the charging system and the information on whether to insure insurance are added to the owner information illustrated in FIG. 7. The charging system includes, for example, metered rate charging and flat rate charging. The metered rate charging is a system in which the owner of the mobile unit 200 pays a toll for each use of the corridor. The flat rate charging is a system in which the owner of the mobile unit 200 can use the corridor for a certain period by paying a predetermined amount of fee in advance. That is, the information on the charging system indicates whether the owner is a metered rate charging payer or a flat rate charging payer. The example of FIG. 12 indicates that the owner of the identification information “001” is a metered rate charging payer. In a case where the owner is a flat rate charging payer, the fee may not be calculated by the calculation unit 131. In this manner, the owner specifying unit 1211 may specify whether the owner is a metered rate charging payer or a flat rate charging payer from the storage means including the information regarding the owner of the mobile unit based on the identification information.

The information on whether to insure insurance indicates whether the owner has insured to the insurance related to the mobile unit 200. The insurance in this case may be such that, for example, the amount of money may be guaranteed in a case where the owner is liable for damages when the mobile unit 200 collides with an object or a person. In addition, the insurance may be such that the amount of money may be guaranteed when it breaks down. The example of FIG. 12 indicates that the owner of the identification information “001” has insurance. In this manner, the owner specifying unit 1211 may specify whether to insure insurance of the owner from the storage means including the information regarding the owner of the mobile unit 200 based on the identification information.

The detection unit 1212 detects entry and exit to and from an area of a corridor having different altitudes. For example, the detection unit 1212 specifies an area where the mobile unit is located from the position information of the mobile unit 200. At this time, the position information includes information indicating the altitude of the mobile unit 200. By also using the information indicating the altitude, the detection unit 1212 detects whether the mobile unit 200 has, for example, entered the area C6 from the area E1 or entered the area C16 from the area E1. Similarly, in a case where the mobile unit 200 exits to the area O1, the detection unit 1212 also uses the information indicating the altitude to detect whether the mobile unit 200 exits from the area C3 or exits from the area C13.

Furthermore, the detection unit 1212 may detect the speed of the mobile unit 200. For example, the detection unit 1212 may detect a moving speed per unit time such as a speed per hour from the position information of the mobile unit 200 acquired as needed.

The transit area specifying unit 1213 specifies a transit area including information indicating an area corresponding to the altitude at which the mobile unit has transited through the corridor. For example, assume that the mobile unit 200 enters the area C6 from the area E1 and exits to the area O1 from the area C3. In this case, the transit area specifying unit 1213 specifies a section from the area C6 to the area C3, which is a section of the corridor A, as the transit area of the mobile unit 200. For example, assume that the mobile unit 200 enters the area C16 from the area E1 and exits to the area O1 from the area C13. In this case, the transit area specifying unit 1213 specifies, as the transit area of the mobile unit 200, a section from the area C16 to the area C13, which is a section of the corridor B higher in altitude than the corridor A.

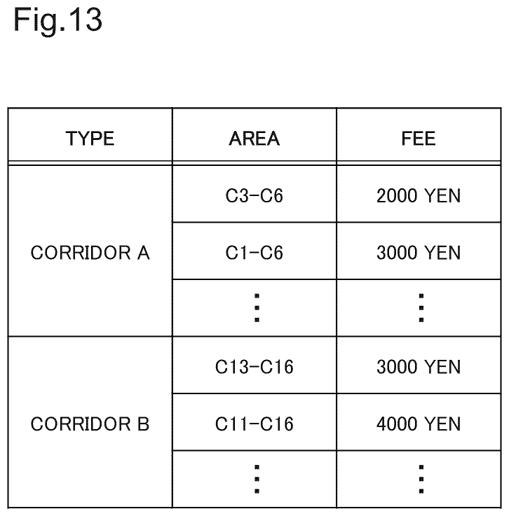

In addition to the process of the calculation unit 130, the calculation unit 131 may perform processes described below. The calculation unit 131 includes a fee calculation unit 1311 and a fee billing unit 1312. The fee calculation unit 1311 calculates a toll based on the corridor information and the transit area. FIG. 13 is a diagram illustrating an example of the corridor information. In the example of FIG. 13, the fee corresponding to each section of the corridor A and the fee corresponding to each section of the corridor B are defined. For example, when the transit area indicates a section from the area C6 to the area C3, the fee calculation unit 1311 calculates “2000 yen” as the toll. Furthermore, for example, when the transit area indicates a section from the area C16 to the area C13, the fee calculation unit 1311 calculates “3000 yen” as the toll. In this manner, the fee calculation unit 1311 may calculate the fee corresponding to the transit area according to the altitude.

As illustrated in FIG. 10, corridors of different altitudes may be formed. If the fee required for transit is cheaper for the corridor A than for the corridor B, the corridor A has a higher possibility of being congested than the corridor B. That is, since there is a high possibility that the corridor B is vacant as compared with the corridor A, the mobile unit 200 can be transited smoothly. For example, in a case where the owner wants to cause the mobile unit 200 to quickly head for the destination, the owner controls the mobile unit 200 to transit through the corridor B. As described above, even when different fees are set for a plurality of corridors having different altitudes, the fee calculation unit 1311 can appropriately calculate the toll.

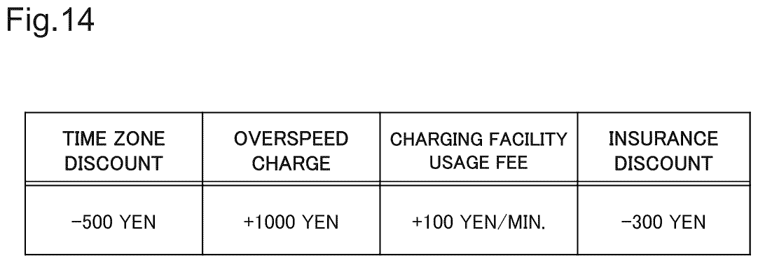

In addition, the fee calculation unit 1311 may further calculate a toll corresponding to various usage situations. At this time, the fee calculation unit 1311 calculates the toll based on the option information included in the corridor information. FIG. 14 is a diagram illustrating an example of option information. The option information is information indicating a fee added to or subtracted from the fee corresponding to the transit area. In the example of FIG. 14, the option information includes items of “time zone discount”, “overspeed charge”, “charging facility utilization charge”, and “insurance discount”. The time zone discount is information indicating a fee defined according to the time at which the mobile unit 200 transited through the corridor. The time zone discount indicates, for example, information indicating that 500 yen is discounted when a corridor is used between 22:00 and 6:00. For example, the fee calculation unit 1311 determines whether the mobile unit 200 has used the corridor in the time zone in which the time zone discount is applied from the information of the time included in the transmitted information. In a case where the time zone discount is applied, the fee calculation unit 1311 calculates a fee obtained by subtracting a fee corresponding to the time zone discount from a fee corresponding to the transit area as the toll.

For example, when the fee corresponding to the transit area is 2000 yen, the fee calculation unit 1311 calculates 1500 yen obtained by subtracting 500 yen from 2000 yen as the toll. As described above, the corridor information may include information indicating a fee defined according to the time when the mobile unit 200 transits through. Then, the fee calculation unit 1311 may calculate the toll according to the time at which the mobile unit 200 transits.

In the example of FIG. 14, the overspeed charge is information indicating a fee required when the mobile unit 200 transits through the corridor at a speed exceeding a predetermined speed. The example of FIG. 14 illustrates that a fee of 1000 yen is added in a case where the speed of the mobile unit 200 detected by the detection unit 1212 exceeds the predetermined speed. For example, when the fee corresponding to the transit area is 2000 yen, the fee calculation unit 1311 calculates 3000 yen obtained by adding 1000 yen to 2000 yen as the toll. As described above, the corridor information may include information indicating a fee defined according to the speed at which the mobile unit transits. Then, the fee calculation unit 1311 may calculate the toll according to the speed at which the mobile unit 200 transits.

Furthermore, in the example of FIG. 14, the charging facility utilization charge is information indicating a fee required when the mobile unit 200 uses the charging facility. The example of FIG. 14 illustrates that the charge required for using the charging facility is 100 yen per minute. The fee calculation unit 1311 calculates a charging facility utilization charge for the mobile unit 200 based on the charging record information acquired by the acquisition unit 111. For example, assume that the charging record information indicates that the charging facility has been used for 10 minutes. In this case, the fee calculation unit 1311 calculates 1000 yen as the charging facility utilization charge. For example, when the fee corresponding to the transit area is 2000 yen, the fee calculation unit 1311 calculates 3000 yen obtained by adding 1000 yen to 2000 yen as the toll. The corridor information may include information indicating a fee required for using a charging facility installed around the corridor. Then, the fee calculation unit 1311 may calculate a fee obtained by adding the fee required for using the charging facility indicated in the charging record information to the fee corresponding to the transit area as the toll.

Furthermore, in the example of FIG. 14, the insurance discount is information indicating a fee defined according to whether the owner of the mobile unit 200 has insurance. The example of FIG. 14 illustrates that the toll is subtracted by 300 yen when the user has insurance. whether the owner of the mobile unit 200 has insurance is specified by the owner specifying unit 1211. For example, in a case where the fee corresponding to the transit area is 2000 yen and the owner has insurance, the fee calculation unit 1311 calculates 1700 yen obtained by subtracting 300 yen from 2000 yen as the toll. In this manner, the fee calculation unit 1311 may calculate different tolls depending on whether the owner has insurance.

Each of the time zone discount, the overspeed charge, the charging facility utilization charge, and the insurance discount can be applied in combination.

### Operation Example of Management Device 101

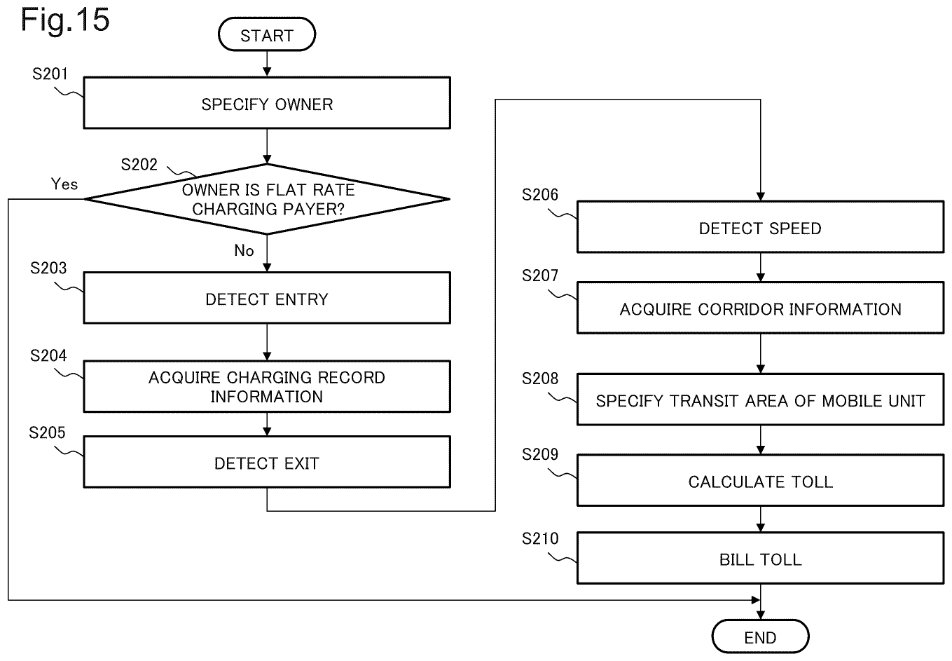

Next, an example of the operation of the management device 101 will be described with reference to FIG. 15. In the present operation example, the acquisition unit 111 acquires the transmitted information including the time when the mobile unit 200 transmitted the transmitted information and the information indicating the altitude of the mobile unit 200 as needed.

FIG. 15 is a flowchart illustrating an example of the operation of the management device 100. The process of the present operation example may be proceeded after the mobile unit 200 is located in an area (e.g., the area E1) in the vicinity of the corridor. In this case, the detection unit 1212 may detect that the mobile unit 200 is located in an area in the vicinity of the corridor.

The owner specifying unit 1211 specifies the owner based on the transmitted information (S201). At this time, the owner specifying unit 1211 specifies, for example, whether the owner has insurance and whether the owner is a metered rate charging payer or a flat rate charging payer. In a case where the owner is a flat rate charging payer (“Yes” in S202), the management device 101 may not perform the subsequent processes. In a case where the owner is not a flat rate charging payer (“No” in S202), the detection unit 1212 detects entry of the mobile unit 200 into the corridor (S203). At this time, for example, the detection unit 1212 detects which one of the plurality of corridors the user has entered from the information on the altitude included in the position information. The acquisition unit 111 acquires the charging record information from the charging facility (S204). The detection unit 1212 detects exit of the mobile unit 200 from the corridor (S205). Furthermore, the detection unit 1212 detects the speed of the mobile unit 200 based on the position information (S206). The acquisition unit 111 acquires the corridor information (S207). The transit area specifying unit 1213 specifies an area of the corridor through which the mobile unit 200 has transited as a transit area (S208). The fee calculation unit 1311 calculates the toll to be billed to the owner of the mobile unit 200 (S209). At this time, for example, the fee calculation unit 1311 calculates, as a toll, a fee obtained by adding or subtracting at least one of a fee defined according to a time at which the mobile unit 200 transits through, a fee defined according to a speed at which the mobile unit transits through, a fee required for using a charging facility, and a fee defined according to whether an owner of the mobile unit 200 has insurance to a fee corresponding to a transit area. Then, the fee billing unit 1312 bills the calculated toll to the billing destination of the owner (S210).

In the present operation example, an example has been described in which, when the owner is a flat rate charging payer, the processes after S203 are not performed. On the other hand, even if the owner is a flat rate charging payer, the processes after S203 may be performed. In this case, for example, in S209, the fee calculation unit 1311 may calculate only the toll based on the fee defined according to the speed at which the mobile unit transits through and the fee required for using the charging facility.

As described above, in the third example embodiment, the position information may include information indicating the altitude of the mobile unit, and the corridor information may include information indicating a fee defined according to the altitude of the corridor. Then, the management device 101 may specify a transit area including information indicating an area corresponding to the altitude at which the mobile unit transited in the corridor, and calculate the toll corresponding to the transit area corresponding to the altitude. Corridors formed in the air may have different tolls depending on the altitude of the corridors. With the above configuration, the management device 101 can calculate an appropriate fee even if the toll differs depending on the altitude of the corridor.

In addition, in the third example embodiment, the corridor information may include information indicating a fee required for using a charging facility installed around the corridor. Then, the management device 101 acquires the charging record information indicating the record in which the mobile unit has used the charging facility, and calculates a fee obtained by adding the fee required for using the charging facility indicated in the charging record information to the fee corresponding to the transit area as the toll. As a result, the management device 101 can calculate an appropriate fee even when the mobile unit 200 uses the charging facility at the time of corridor transit.

Furthermore, the corridor information may include information indicating a fee defined according to time. Then, the management device 101 may calculate, as the toll, a fee obtained by reflecting the fee corresponding to the time when the mobile unit transits to the fee corresponding to the transit area. Furthermore, the corridor information may include information indicating a fee defined according to speed. Then, the management device 101 may calculate, as the toll, a fee obtained by reflecting the fee corresponding to the speed at which the mobile unit transits to the fee corresponding to the transit area. As a result, in a case where the fee is defined according to the speed or the time when the mobile unit 200 transits through the corridor, the management device 101 can calculate an appropriate fee according to the speed or the time.

In addition, the management device 101 of the third example embodiment may acquire the transmitted information including the position information and the identification information of the mobile unit, and may specify whether the owner has insurance from the storage means including the information regarding the owner of the mobile unit based on the identification information. Then, the management device 101 may calculate different tolls according to whether the owner has insurance. As a result, the management device 101 can calculate a fee corresponding to whether the owner has insurance with respect to the use of the corridor.

### Fourth Example Embodiment

Next, a management device according to a fourth example embodiment will be described. In the fourth example embodiment, an example in which a management device acquires a flight plan of a mobile unit will be described. Description of contents redundant with the contents described in the first, second and third example embodiments will be partially omitted. Furthermore, in the present example embodiment, it is assumed that a corridor illustrated in the example of FIG. 10 is formed.

### [Details of Management Device 102]

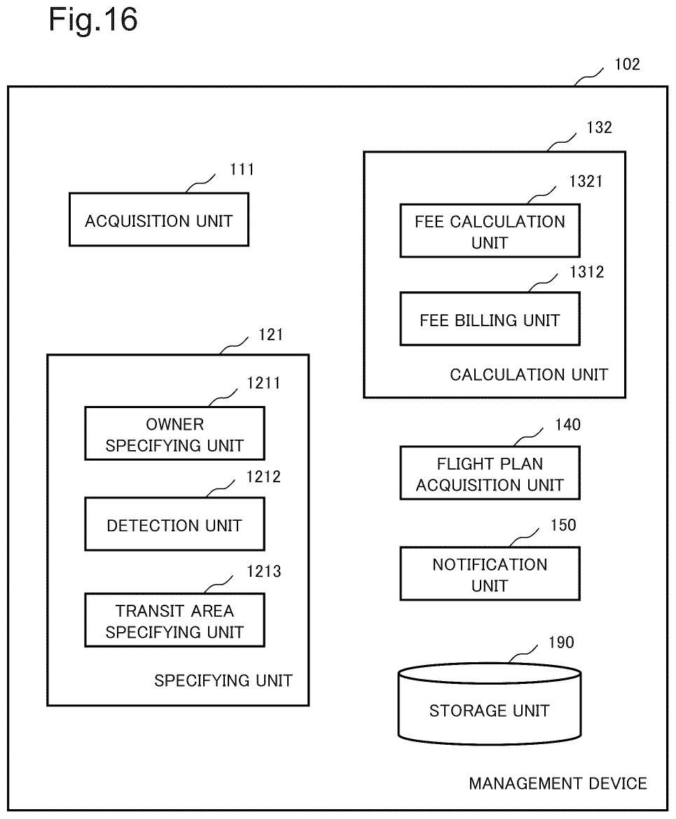

FIG. 16 is a block diagram illustrating an example of a functional configuration of the management device 102 of the fourth example embodiment. As illustrated in FIG. 16, the management device 102 includes an acquisition unit 111, a specifying unit 121, a calculation unit 132, a flight plan acquisition unit 140, and a notification unit 150. In addition, the management device 102 includes a storage device 190.

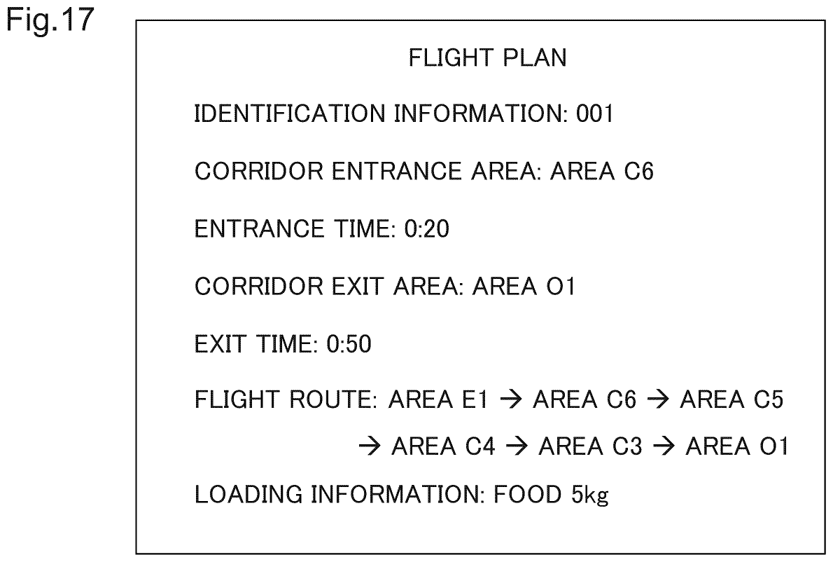

The flight plan acquisition unit 140 acquires a flight plan of the mobile unit 200. The flight plan includes information on a route on which the mobile unit 200 flies. For example, the flight plan is written in advance by the owner of the mobile unit 200 and received by the management device 102. The flight plan is stored in the storage device 190. FIG. 17 is a diagram illustrating an example of a flight plan. In the example of FIG. 17, the flight plan shows identification information, a corridor entrance area, entrance time, a corridor exit area, exit time, a flight route, and loading information. In this example, it is indicated that the mobile unit having the identification information 001 enters the area C6 at 0:20, transits through the areas C5 to C3, and exits to the area O1 at 0:50, and that the mobile unit is loaded with 5 kg of food. The example of the flight plan is not limited to this example. For example, the flight plan may indicate information on a place where the mobile unit 200 departs and a place where the mobile unit 200 arrives.

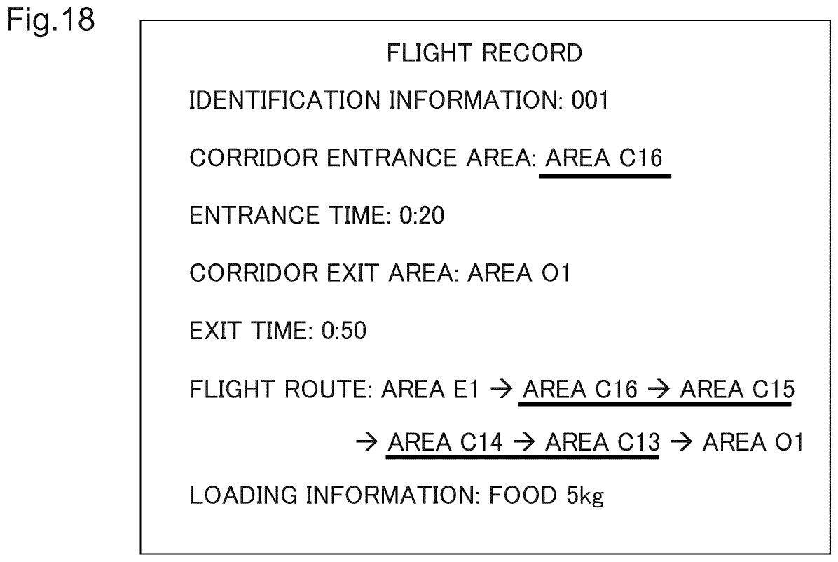

The notification unit 150 notifies the owner of the flight record. The flight record includes information on a route on which the mobile unit 200 actually flew. FIG. 18 is a diagram illustrating an example of a flight record. In the example of FIG. 18, the flight record indicates identification information, a corridor entrance area, entrance time, a corridor exit area, exit time, and a flight route. In this example, it is indicated that the mobile unit having the identification information 001 enters the area C16 at 0:20, transits through the areas C15 to C13, and exits to the area O1 at 0:50. The notification unit 150 generates such a flight record and notifies the owner's contact of the generated flight record. Here, the notification unit 150 may compare the flight plan with the flight record. For example, it is assumed that the flight plan illustrated in FIG. 17 is acquired and the flight record illustrated in FIG. 18 is generated. At this time, it can be seen that the mobile unit of the identification information 001 has transited through a route different from the flight route indicated in the flight plan. The notification unit 150 may notify the owner that the route on which the mobile unit of the identification information 001 actually flew is different from the flight plan. Here, the notification unit 150 may highlight a portion different from the flight plan in the flight record to be notified to the owner. In the example of FIG. 18, a portion different from the flight plan in the flight record is underlined.

In addition to the process of the calculation unit 131, the calculation unit 132 may perform processes described below. The calculation unit 132 includes a fee calculation unit 1321 and a fee billing unit 1312. Then, the fee calculation unit 1321 may calculate the toll based on the loading information of the mobile unit 200. In this case, the corridor information includes, for example, information indicating a fee defined according to the loading amount, such as 100 yen per 1 kg. In this case, for example, when the mobile unit 200 is loaded with 5 kg of food, the fee calculation unit 1321 calculates a fee obtained by adding 500 yen to the fee corresponding to the transit area as the toll. In this manner, the fee calculation unit 1321 may calculate the fee obtained by adding the fee corresponding to the loading amount of the mobile unit included in the flight plan to the fee corresponding to the transit area as the toll.

In addition, the fee calculation unit 1321 may add a predetermined amount of fee to the toll when the flight plan and the flight record are different. For example, when the flight route indicated in the flight plan is different from the flight route indicated in the flight record, 500 yen may be added to the toll.

### Operation Example of Management Device 102

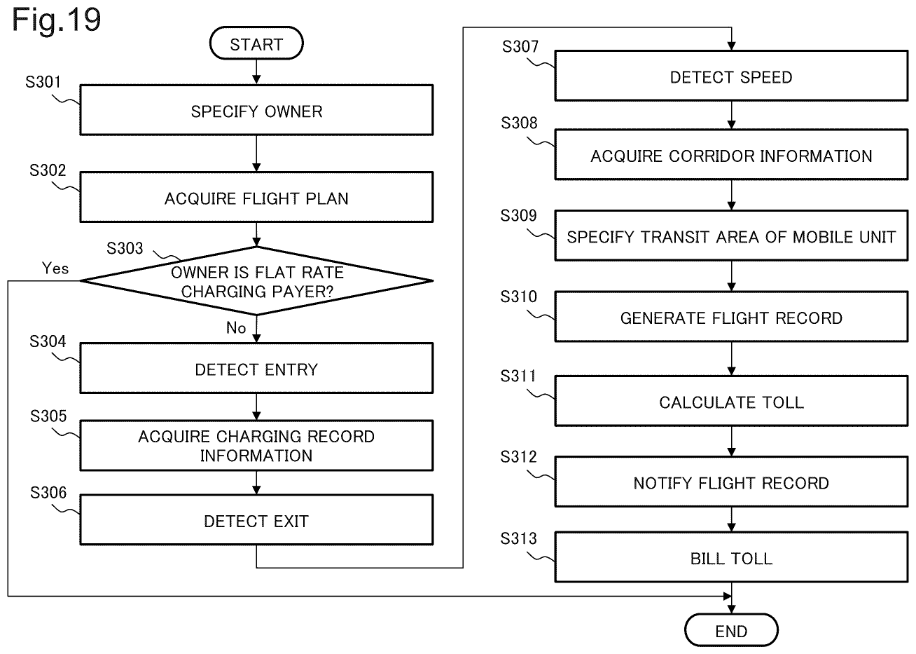

Next, an example of the operation of the management device 102 will be described with reference to FIG. 19. In the present operation example, the acquisition unit 111 acquires the transmitted information as needed.

The owner specifying unit 1211 specifies the owner based on the transmitted information (S301). The flight plan acquisition unit 140 acquires a flight plan (S302). For example, the flight plan acquisition unit 140 acquires the flight plan including the identification information from the storage device 190 based on the identification information included in the transmitted information. Since the processes of S303 to S309 are similar to the processes of S202 to S208 of FIG. 15, the description thereof will be omitted.

The notification unit 150 generates a flight record. For example, the notification unit 150 generates a flight record based on information regarding entry and exit of the corridor detected by the detection unit 1212 and information regarding the transit area specified by the transit area specifying unit 1213. The fee calculation unit 1321 calculates a toll (S311). At this time, the fee calculation unit 1321 may reflect, for example, the loading information of the mobile unit 200 and the fee based on the difference between the flight plan and the flight record on the toll. The notification unit 150 notifies the owner of the flight record (S312). The fee billing unit 1312 bills the toll to the owner (S313).

As described above, the management device 102 of the fourth example embodiment acquires the flight plan of the mobile unit. Then, when the information indicating the fee defined according to the loading amount is included in the corridor information, the management device 102 may calculate a fee obtained by adding a fee corresponding to the loading amount of the mobile unit included in the flight plan to the fee corresponding to the transit area as the toll. As a result, the management device 102 can calculate an appropriate fee according to the loading amount when the fee is determined according to the loading amount of the mobile unit when transiting through the corridor.

In addition, the management device 102 may notify the owner of the mobile unit of the flight record of the mobile unit. At this time, if there is a difference between the flight plan and the flight record, the management device 102 may notify the owner that there is a difference. As a result, the management device 102 can cause the owner of the mobile unit to confirm whether the mobile unit has moved as planned.

### Configuration Example of Hardware of Management Device

The hardware constituting the management device of the first, second, third, and fourth example embodiments will be described. FIG. is a block diagram illustrating an example of a hardware configuration of a computer device that implements the management device according to each example embodiment. In the computer device 90, the management device and the management method described in each example embodiment and each modified example are achieved.

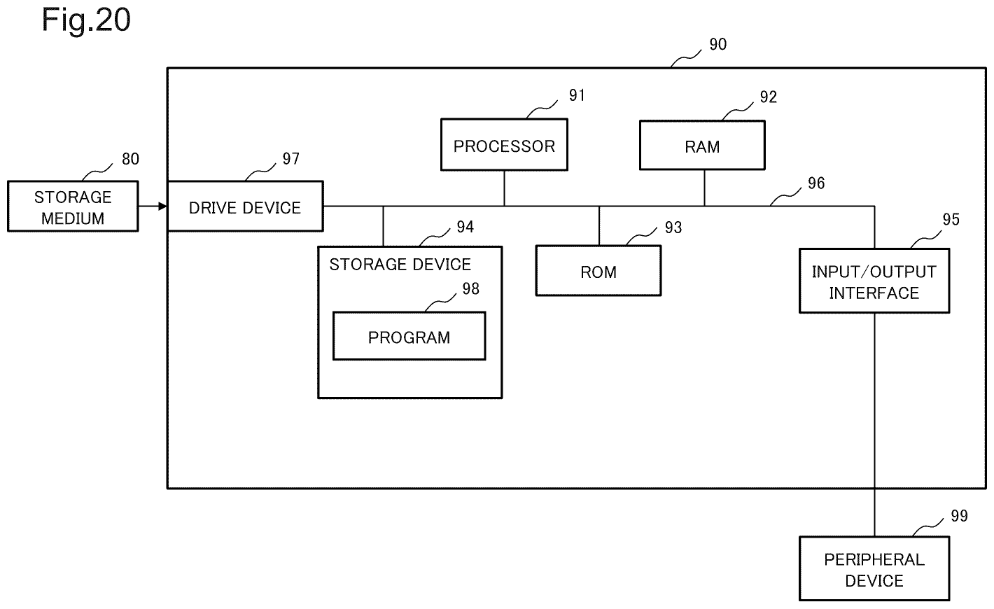

As illustrated in FIG. 20, the computer device 90 includes a processor 91, a random access memory (RAM) 92, a read only memory (ROM) 93, a storage device 94, an input/output interface 95, a bus 96, and a drive device 97. The management device may be achieved by a plurality of electric circuits.

The storage device 94 stores a program (computer program) 98. The processor 91 executes the program 98 of the management device by using the RAM 92. Specifically, for example, the program 98 includes a program that causes a computer to execute the processes illustrated in FIGS. 4, 8, 15, and 19. When the processor 91 executes the program 98, the function of each component of the management device is achieved. The program 98 may be stored in the ROM 93. In addition, the program 98 may be recorded in the storage medium 80 and read using the drive device 97, or may be transmitted from an external device (not illustrated) to the computer device 90 via a network (not illustrated).

The input/output interface 95 exchanges data with a peripheral device (keyboard, mouse, display device etc.) 99. The input/output interface 95 functions as a means for acquiring or outputting data. The bus 96 connects the components.

There are various modified examples for the method of achieving the management device. For example, the management device can be achieved as a dedicated device. In addition, the management device can be achieved based on a combination of a plurality of devices.

Processing methods for causing a storage medium to record a program for achieving each component in a function of each example embodiment, reading the program recorded in the storage medium as a code, and executing the program in a computer are also included in the scope of each example embodiment. That is, a computer-readable storage medium is also included in the scope of each example embodiment. In addition, a storage medium in which the above-described program is recorded and the program itself are also included in each example embodiment.

The storage medium is, for example, a floppy (registered trademark) disk, a hard disk, an optical disk, a magneto-optical disk, a compact disc (CD)-ROM, a magnetic tape, a nonvolatile memory card, or a ROM, but is not limited to this example. In addition, the program recorded in the storage medium is not limited to a program that executes processing alone, and programs that operate on an operating system (OS) to execute processing in cooperation with other software and functions of an extension board are also included in the scope of each example embodiment.

Although the present disclosure has been described with reference to the example embodiments, the present disclosure is not limited to these example embodiments. Various changes that can be understood by those skilled in the art can be made to the configuration and details of the present invention within the scope of the present invention.

The above-described example embodiments and modified examples can be appropriately combined.

Some or all of the above example embodiments may be described as the following supplementary notes, but are not limited to the following.

### <Supplementary Note>

### [Supplementary Note 1]

A management device comprising:
an acquisition means configured to acquire position information of a flying mobile unit, and corridor information which includes information on tolls and which is defined for a corridor that is a specific airspace,
a specifying means configured to specify, based on the position information, a transit area, which is an area in the corridor that the mobile unit has transited, and
a calculation means configured to calculate a toll corresponding to the transit area based on the corridor information.

### [Supplementary Note 2]

The management device according to supplementary note 1, wherein
the corridor information includes information indicating a fee defined for each section of the corridor,
the specifying means specifies a section of the corridor through which the mobile unit has transited as the transit area, and
the calculation means calculates a fee corresponding to a section indicated in the transit area as a toll.

### [Supplementary Note 3]

The management device according to supplementary note 1, wherein
the corridor information includes information indicating a fee defined for each distance the corridor has transited,
the specifying means specifies a distance the mobile unit has transited in the corridor as the transit area, and
the calculation means calculates a fee corresponding to a distance indicated in the transit area as a toll.

### [Supplementary Note 4]

The management device according to any one of supplementary notes 1 to 3, wherein
the specifying means detects entry and exit of the mobile unit to and from the corridor based on the position information.

### [Supplementary Note 5]

The management device according to any one of supplementary notes 1 to 4, wherein
the position information includes information indicating an altitude of the mobile unit,
the corridor information includes information indicating a fee defined according to an altitude of the corridor,
the specifying means specifies the transit area including information indicating an area corresponding to an altitude at which the mobile unit has transited in the corridor, and
the calculation means calculates a toll corresponding to the transit area according to an altitude.

### [Supplementary Note 6]

The management device according to any one of supplementary notes 1 to 5, wherein
the corridor information includes information indicating a fee required for using a charging facility installed around the corridor,
the acquisition means acquires charging record information indicating a record in which the mobile unit has used the charging facility, and
the calculation means calculates, as a toll, a fee obtained by adding a fee required for using the charging facility indicated in the charging record information to a fee corresponding to the transit area.

### [Supplementary Note 7]

The management device according to any one of supplementary notes 1 to 6, further comprising:
a flight plan acquisition means configured to acquire a flight plan of the mobile unit, wherein
the corridor information includes information indicating a fee defined according to a loading amount, and
the calculation means calculates, as a toll, a fee obtained by adding a fee corresponding to a loading amount of the mobile unit included in the flight plan to the fee corresponding to the transit area.

### [Supplementary Note 8]

The management device according to any one of supplementary notes 1 to 7, wherein
the acquisition means acquires transmitted information including the position information and identification information of the mobile unit,
the specifying means specifies whether an owner has insurance from a storage means including information regarding the owner of the mobile unit based on the identification information, and
the calculation means calculates different tolls depending on whether the owner has insurance.

### [Supplementary Note 9]

The management device according to any one of supplementary notes 1 to 7, wherein
the acquisition means acquires transmitted information including the position information and identification information of the mobile unit,
the specifying means specifies whether an owner is a metered rate charging payer or a flat rate charging payer from a storage means including information regarding the owner of the mobile unit based on the identification information, and
the calculation means calculates a toll corresponding to the transit area in a case where the owner is a metered rate charging payer.

### [Supplementary Note 10]

The management device according to any one of supplementary notes 1 to 9, wherein
the corridor information includes information indicating a fee determined according to time, and
the calculation means calculates, as a toll, a fee obtained by reflecting a fee corresponding to a time at which the mobile unit transits on the fee corresponding to the transit area.

### [Supplementary Note 11]

The management device according to any one of supplementary notes 1 to 10, wherein
the corridor information includes information indicating a fee defined according to speed, and
the calculation means calculates, as a toll, a fee obtained by reflecting a fee corresponding to a speed at which the mobile unit transits on the fee corresponding to the transit area.

### [Supplementary Note 12]

A management method comprising:
acquiring position information of a flying mobile unit, and corridor information which includes information on tolls and which is defined for a corridor that is a specific airspace;
specifying, based on the position information, a transit area which is an area in the corridor that the mobile unit has transited; and
calculating a toll corresponding to the transit area based on the corridor information.

### [Supplementary Note 13]

A computer-readable storage medium storing a program for causing a computer to execute:
a process of acquiring position information of a flying mobile unit, and corridor information which includes information on tolls and which is defined for a corridor that is a specific airspace,
a process of specifying, based on the position information, a transit area, which is an area in the corridor that the mobile unit has transited, and
a process of calculating a toll corresponding to the transit area based on the corridor information.

### REFERENCE SIGNS LIST

100, 101, 102 management device
110, 111 acquisition unit
120, 121 specifying unit
130, 131, 132 calculation unit
140 flight plan acquisition unit
150 notification unit
200 mobile unit

What is claimed is:

1. A management device comprising:
a memory configured to store instructions; and
at least one processor configured to execute the instructions to perform:
acquiring position information of a flying mobile unit, and corridor information which includes information on tolls and which is defined for a corridor that is a specific airspace;
specifying, based on the position information, a transit area, which is an area in the corridor that the mobile unit has transited; and
calculating a toll corresponding to the transit area based on the corridor information.

2. The management device according to claim 1, wherein
the corridor information includes information indicating a fee defined for each section of the corridor, and
the at least one processor is configured to execute the instructions to perform:
specifying a section of the corridor through which the mobile unit has transited as the transit area, and
calculating a fee corresponding to a section indicated in the transit area as a toll.

3. The management device according to claim 1, wherein
the corridor information includes information indicating a fee defined for each distance the corridor has transited, and
the at least one processor is configured to execute the instructions to perform:
specifying a distance the mobile unit has transited in the corridor as the transit area, and
calculating a fee corresponding to a distance indicated in the transit area as a toll.

4. The management device according to claim 1, wherein
the at least one processor is configured to execute the instructions to perform:
detecting entry and exit of the mobile unit to and from the corridor based on the position information.

5. The management device according to claim 1, wherein
the position information includes information indicating an altitude of the mobile unit,
the corridor information includes information indicating a fee defined according to an altitude of the corridor, and
the at least one processor is configured to execute the instructions to perform:
specifying the transit area including information indicating an area corresponding to an altitude at which the mobile unit has transited in the corridor, and
calculating a toll corresponding to the transit area according to an altitude.

6. The management device according to claim 1, wherein
the corridor information includes information indicating a fee required for using a charging facility installed around the corridor, and
the at least one processor is configured to execute the instructions to perform:
acquiring charging record information indicating a record in which the mobile unit has used the charging facility, and
calculating, as a toll, a fee obtained by adding a fee required for using the charging facility indicated in the charging record information to a fee corresponding to the transit area.

7. The management device according to claim 1 wherein
the at least one processor is further configured to execute the instructions to perform:
acquire acquiring a flight plan of the mobile unit, wherein
the corridor information includes information indicating a fee defined according to a loading amount, and
the calculation means calculates, as a toll, a fee obtained by adding a fee corresponding to a loading amount of the mobile unit included in the flight plan to the fee corresponding to the transit area.

8. The management device according to claim 1, wherein
the at least one processor is configured to execute the instructions to perform:
acquiring transmitted information including the position information and identification information of the mobile unit,
specifying whether an owner has insurance from a storage-means including information regarding the owner of the mobile unit based on the identification information, and
calculating different tolls depending on whether the owner has insurance.

9. The management device according to claim 1, wherein
the at least one processor is configured to execute the instructions to perform:
acquiring transmitted information including the position information and identification information of the mobile unit,
specifying whether an owner is a metered rate charging payer or a flat rate charging payer from a storage including information regarding the owner of the mobile unit based on the identification information, and
calculating a toll corresponding to the transit area in a case where the owner is a metered rate charging payer.

10. The management device according to claim 1, wherein
the corridor information includes information indicating a fee determined according to time, and
the at least one processor is configured to execute the instructions to perform:
calculating, as a toll, a fee obtained by reflecting a fee corresponding to a time at which the mobile unit transits on the fee corresponding to the transit area.

11. The management device according to claim 1, wherein
the corridor information includes information indicating a fee defined according to speed, and
the at least one processor is configured to execute the instructions to perform:
calculating, as a toll, a fee obtained by reflecting a fee corresponding to a speed at which the mobile unit transits on the fee corresponding to the transit area.

12. A management method comprising:
acquiring position information of a flying mobile unit, and corridor information which includes information on tolls and which is defined for a corridor that is a specific airspace;
specifying, based on the position information, a transit area which is an area in the corridor that the mobile unit has transited; and
calculating a toll corresponding to the transit area based on the corridor information.

13. A non-transitory computer-readable storage medium storing a program for causing a computer to execute:
a process of acquiring position information of a flying mobile unit, and corridor information which includes information on tolls and which is defined for a corridor that is a specific airspace,
a process of specifying, based on the position information, a transit area, which is an area in the corridor that the mobile unit has transited, and
a process of calculating a toll corresponding to the transit area based on the corridor information.

14. The management method according to claim 12, wherein
the corridor information includes information indicating a fee defined for each section of the corridor, and
the management method comprises:
specifying a section of the corridor through which the mobile unit has transited as the transit area, and
calculating a fee corresponding to a section indicated in the transit area as a toll.

15. The management method according to claim 12, wherein
the corridor information includes information indicating a fee defined for each distance the corridor has transited, and
the management method comprises:
specifying a distance the mobile unit has transited in the corridor as the transit area, and
calculating a fee corresponding to a distance indicated in the transit area as a toll.

16. The management method according to claim 12, wherein
the management method comprises:
detecting entry and exit of the mobile unit to and from the corridor based on the position information.

17. The non-transitory computer-readable storage medium according to claim 13, wherein
the corridor information includes information indicating a fee defined for each section of the corridor, and
the program causes the computer to perform:
specifying a section of the corridor through which the mobile unit has transited as the transit area, and
calculating a fee corresponding to a section indicated in the transit area as a toll.

18. The non-transitory computer-readable storage medium according to claim 13, wherein
the corridor information includes information indicating a fee defined for each distance the corridor has transited, and
the program causes the computer to perform:
specifying a distance the mobile unit has transited in the corridor as the transit area, and
calculating a fee corresponding to a distance indicated in the transit area as a toll.

19. The non-transitory computer-readable storage medium according to claim 13, wherein
the program causes the computer to perform:
detecting entry and exit of the mobile unit to and from the corridor based on the position information.
